(19) United States
(12) Patent Application Publication
(10) Pub. No.: US 2024/0281129 A1
(43) Pub. Date: Aug. 22, 2024

(54) METHOD AND APPARATUS FOR PROCESSING INFORMATION, ELECTRONIC DEVICE AND STORAGE MEDIUM

(71) Applicant: Beijing Zitiao Network Technology Co., Ltd., Beijing (CN)

(72) Inventor: Zhifeng LIN, Beijing (CN)

(21) Appl. No.: 18/582,277

(22) Filed: Feb. 20, 2024

(30) Foreign Application Priority Data
Feb. 20, 2023 (CN) 202310157417.8

(51) Int. Cl. G06F 3/04847; G06F 40/177

(52) U.S. Cl. CPC G06F 3/04847; G06F 40/177

(57) ABSTRACT

The present disclosure provides a method and apparatus for processing information, an electronic device and a storage medium. An method for processing information includes: generating a target button field in a cell of a target table of a first online document in response to a first operation event, where a target button is displayed in the target button field, the target button field is a button field, a field type of the button field is button, the target button field has a target trigger condition, and the target button field is associated with a target processing flow; and executing the target processing flow in response to determining that the target trigger condition of the target button field is satisfied. The present disclosure enriches types of fields and automates the functions.

### CROSS-REFERENCE TO RELATED APPLICATION(S)

This application claims priority to Chinese Application No. 202310157417.8 filed Feb. 20, 2023, the disclosure of which is incorporated herein by reference in its entity.

### FIELD

The present disclosure relates to the technical field of computers, and particularly relates to a method and apparatus for processing information, an electronic device and a storage medium.

### BACKGROUND

Online documents, such as online forms, allow users to access documents from different locations. During the use of an online document, a user may need to execute some processing flows with certain conditions satisfied.

### SUMMARY

The present disclosure provides a method and apparatus for processing information, an electronic device and a storage medium.

The present disclosure uses the following technical solutions.

In some embodiments, the present disclosure provides a method for processing information. The method for processing information includes: generating a target button field in a cell of a target table of a first online document in response to a first operation event, where a target button is displayed in the target button field, the target button field is a button field, a field type of the button field is button, the target button field has a target trigger condition, and the target button field is associated with a target processing flow; and executing the target processing flow in response to determining that the target trigger condition of the target button field is satisfied.

In some embodiments, the present disclosure provides an apparatus for processing information. The apparatus for processing information includes: a generation unit and a control unit.

The generation unit is configured to generate a target button field in a cell of a target table of a first online document in response to a first operation event, where a target button is displayed in the target button field, the target button field is a button field, a field type of the button field is button, the target button field has a target trigger condition, and the target button field is associated with a target processing flow.

The control unit is configured to execute the target processing flow in response to determining that the target trigger condition of the target button field is satisfied.

In some embodiments, the present disclosure provides an electronic device. The electronic device includes at least one memory and at least one processor.

The memory is configured to store a program code, and the processor is configured to call the program code stored in the memory, to execute the above method.

In some embodiments, the present disclosure provides a computer-readable storage medium. The computer-readable storage medium stores a program code. The program code causes, when executed by a processor, the processor to execute the above method. According to the method for processing information provided in the embodiments of the

present disclosure, the button field with a type of button is added in the table of the first online document. When the target trigger condition of the target button field is satisfied, the target processing flow is automatically executed, such that the types of fields are enriched, and functions are automated.

### BRIEF DESCRIPTION OF THE DRAWINGS

The above and other features, advantages, and aspects of embodiments of the present disclosure will become more apparent with reference to the following particular embodiments in conjunction with the drawings. The same or similar reference numerals refer to the same or similar elements throughout the drawings. It should be understood that the drawings are schematic, and that the parts and elements are not necessarily drawn to scale.

FIG. 1 is a flowchart of a method for processing information according to an embodiment of the present disclosure;

FIGS. 2-3 are schematic diagrams of a first online document according to an embodiment of the present disclosure;

FIGS. 4 and 5 are schematic diagrams of a first setting interface according to an embodiment of the present disclosure;

FIGS. 6 and 7 are schematic diagrams of a second setting interface according to an embodiment of the present disclosure;

FIGS. 8 and 9 are schematic diagrams of a first setting interface according to an embodiment of the present disclosure;

FIGS. 10 and 11 are schematic diagrams of a second setting interface according to an embodiment of the present disclosure; and

FIG. 12 is a schematic structural diagram of an electronic device according to an embodiment of the present disclosure.

### DETAILED DESCRIPTION OF EMBODIMENTS

Embodiments of the present disclosure are described in more detail below with reference to the drawings. Although some embodiments of the present disclosure are shown in the drawings, it should be understood that the present disclosure may be embodied in various forms and should not be construed as being limited to the embodiments set forth herein. On the contrary, these embodiments are provided, such that the present disclosure will be understood more thoroughly and completely. It should be understood that the drawings and embodiments of the present disclosure are for illustrative purposes merely and are not intended to limit the scope of protection of the present disclosure.

It should be understood that various steps recited in the method embodiments of the present disclosure can be performed in orders and/or in parallel. Furthermore, the method embodiments can include additional steps and/or omit to execute the illustrated steps. The scope of the present disclosure is not limited in this respect.

As used herein, the term “comprise” or “include” and their variations are open-ended, that is, “comprise but not limited to” and “include but not limited to”. The term “based on” is “based at least in part on”. The term “an embodiment” means “at least one embodiment”. The term “another embodiment” means “at least one further embodiment”. The term “some embodiments” means “at least some embodiments”. Definitions for other terms are given in the description below.

It should be noted that concepts such as “first” and “second” mentioned in the present disclosure are merely used to distinguish different apparatuses, modules or units, and are not used to limit the order of functions executed by these apparatuses, modules or units or their interdependence.

It should be noted that the modification with “a” and “an” in the present disclosure is intended to be illustrative rather than limitative, and should be understood by those skilled in the art as “one or more” unless the context clearly dictates otherwise.

The names of messages or information exchanged between a plurality of apparatuses in the embodiments of the present disclosure are merely for illustrative purposes, and are not intended to limit the scope of these messages or information.

The solutions provided in embodiments of the present disclosure will be described in detail below with reference to the accompanying drawings.

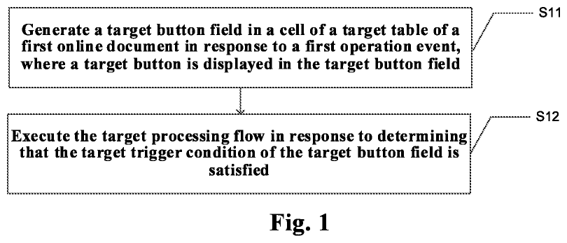

As shown in FIG. 1, FIG. 1 is a flowchart of a method for processing information according to an embodiment of the present disclosure. The method includes the following steps.

S11, a target button field is generated in a cell of a target table of a first online document in response to a first operation event, where a target button is displayed in the target button field.

In some embodiments, the method provided in the present disclosure may be used in terminals, servers, etc. In some embodiments, the first operation event may include one or more operations. The first operation event may include an operation to create a button field and an operation to set a target button field. In some embodiments, the first online document may be a table document or a non-table document containing tables. The target table is a table or a sub-table inserted in the first online document. In some embodiments, the table has a field, the field may be a column of cells, the target button is a button in the column of cells, a button in the target button field is the target button, and the button may be automatically generated in the button field after the button field is generated. Different from a table in the related art, the table in the present disclosure is additionally provided with a button field. The target button field may be any button field. A field type of the button field is button, a content in the button field is a button, and the target button is a button in the target button field. The button in the button field is located in a cell of the button field rather than hovering over the button field. In some embodiments, no content other than a button may be inputted in the button field, that is, the button field may only have a button, and text or graphics may be displayed on the button. In some other embodiments, the button field may have other content, but must have a button. In some embodiments, the button field has an associated trigger condition. The button field may be associated with the processing flow. The trigger condition is a condition for triggering the button in the button field, and the trigger condition may be, for example, clicking the button by default. The target button field has a target trigger condition, the target trigger condition is a trigger condition associated with the target button, and the target button field is associated with the target processing flow. In some embodiments, the target trigger condition includes at least one of the conditions: a new record is added to the target table, a record in the target table is changed, a preset time is reached, and the target button is clicked. The target trigger condition may be target button click by default. A record may be a row of data in the table. In some embodiments, the target processing flow includes at least one of adding a record to the table, deleting a record from the table, modifying a record in the table, searching for a record in the table, sending information through a target client, creating a task item, jumping to a target link, running a script, creating a copy, etc. In some embodiments, a target button being displayed in the target button field may be that, for example, one button is displayed in each cell of the target button field.

In some embodiments, the target button displayed in the present disclosure may be a control having an interaction capability. The interaction capability refers to being capable of receiving a trigger operation such as clicking or tapping from a user, and a specific style of the button is not limited herein.

The control can receive an instruction from the user and execute a task flow (processing flow) bound to the control according to the instruction.

S12, the target processing flow is executed in response to determining that the target trigger condition of the target button field is satisfied.

In some embodiments, in a case that the target trigger condition of the target button field is satisfied, it may be considered that the target button field is triggered, and then the target processing flow is automatically executed. The target processing flow includes one or more preset steps.

In some embodiments of the present disclosure, the button field with a button type is added in the table of the first online document. When the target trigger condition of the target button field is satisfied, the target processing flow is automatically executed, such that the types of fields are increased, and functions are automated.

In some embodiments of the present disclosure, a display style of the target button is relevant to at least one of an enabling state of the target button, an interaction situation between the target button and a control identifier, use permission of a current user for the target button, and an execution situation of the target processing flow.

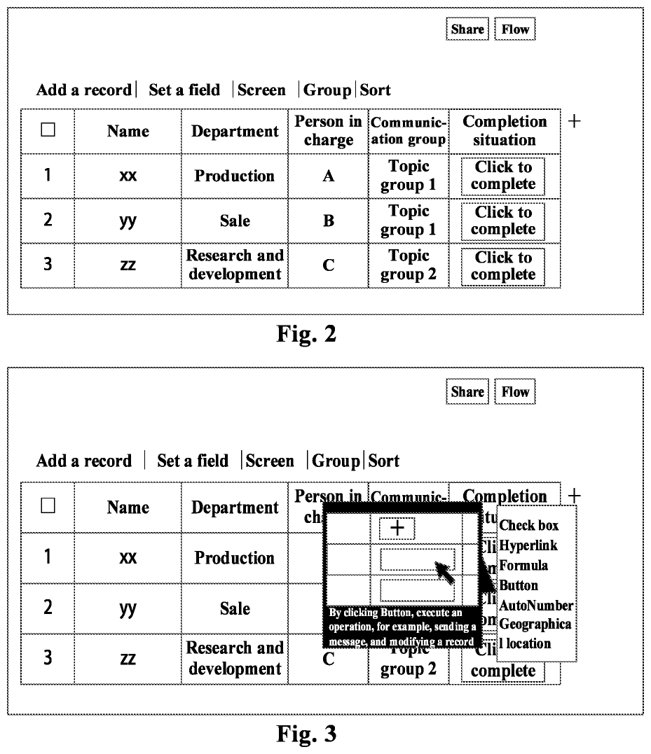

In some embodiments, FIG. 2 illustratively shows contents of the first online document. It can be seen that there is a table, and a “Click to complete” button is displayed in a column of completion situation. A cell where “Click to complete” is located is a button field, and the button “Click to complete” is displayed therein. As shown in FIG. 2, the first document has a control for adding a field (a plus sign in an upper right corner of a table in FIG. 2). After the control is triggered, as shown in FIG. 3, a field type to be added is displayed. As shown in FIG. 3, a pop-up box displays an option of a button field (“Button” under ‘Formula” in the box in FIG. 3) for selection. After the option of a button field is triggered by clicking, etc., a button field is created. When the button field is selected but not triggered, a guide content (a pop-up box pointing to the option of “button” in FIG. 3) may be displayed as shown in FIG. 3. One or two of a guide pattern and guide text may be displayed in the guide content. The guide pattern may be a dynamic pattern, and is configured to display a button field, created after the option of a button field is triggered, in the form of a pattern, and as shown in FIG. 3, the pattern is displayed to show a style of a created button field. A function of a button field may be explained through the guide text, for example, as shown in FIG. 3, “by clicking Button, execute an operation, for example, sending a message, and modifying a record”.

In some embodiments, the display style of the target button is not fixed. An enabling state of the target button includes an available state and an unavailable state, and the target button may be displayed as non-gray when in the available state and gray when in the unavailable state. The control identifier may be a mouse. The interaction situation between the target button and the control identifier may include situations that the control identifier is focused on the target button, and that the control identifier clicks the target button. The target button may be highlighted when the control identifier is focused on the target button without clicking. The target button may be darkened when the control identifier clicks the target button. An execution situation of the target processing flow may include being executed, executed completely, etc. In a case that the target processing flow is being executed, a first symbol may be displayed in the target button, to indicate that the target processing flow is being processed. The first symbol may be a dynamic symbol. In a case that the target processing flow is executed completely, a second symbol may be displayed in the target button. The second symbol may be “√”. In this way, an execution state of the target processing flow may be determined directly through different display styles of the target button. In some embodiments, text may be displayed in the target button as a button copy in a case that the target button cannot display the button copy completely due to size or the like.

In some embodiments of the present disclosure, the enabling state of the target button is relevant to a presence state and/or a validity state of the target processing flow. In some embodiments, the target processing flow needs to be executed under the condition that the target trigger condition is satisfied. In a case that the processing flow exists, the target button may be triggered. In a case that the target processing flow is deleted, that is, does not exist, the target processing flow cannot be executed, that is, the target button needs to be disabled. Therefore, the enabling state of the target button needs to be adjusted according to whether the target processing flow exists. In some other embodiments, the target processing flow has a validity state, that is, whether the target processing flow is valid. In a case that the target processing flow is valid, the target processing flow can be executed, and the target button can be used. In a case that the target processing flow is invalid, the target processing flow cannot be executed, and the target button needs to be disabled.

In some embodiments of the present disclosure, the button field is associated with a trigger condition and an execution operation executed in response to determining that the trigger condition is satisfied; and a processing flow is associated with a start condition and an operation content executed in response to determining that the target start condition is satisfied.

In some embodiments, the button field is associated with the trigger condition, and executes the associated execution operation when the trigger condition is satisfied. The processing flow is associated with a start condition, and executes an execution operation content associated with the processing flow when the start condition is satisfied. A target start condition of the target processing flow includes the target button field in the target table and the target trigger condition. A target operation content of the target processing flow is a specific operation content of a target execution operation associated with the target button field. In some embodiments, the target button field and the target processing flow are associated through a target start condition. The target start condition may specifically be that the target button field satisfies a target trigger condition. For example, the target trigger condition may be clicking a button. The target start condition includes both the clicking a button and the target button field of the target table, that is, it is required to satisfy that a button is clicked, and moreover, it is required to satisfy that the clicked button is located in the target button field of the target table. In some embodiments of the present disclosure, the target execution operation of the target button field may be configured to indicate an operation type, and the target operation content is an operation content of the operation type. For example, the target execution operation may be to send a message, and specifically, the target operation content may be to send a message to someone. The target execution operation may be to delete a record, and specifically, the target operation content may be to delete a certain record. In some embodiments of the present disclosure, the button field and the processing flow are independent of each other. The button field is associated with the processing flow in such a manner that the start condition includes or is equal to the trigger condition. In this way, since the processing flow and the button field are independent, coupling is reduced. The processing flow may be written in advance, and the button field may be set in advance. An association relation may be established according to needs, so as to decouple the content of the processing flow from the target execution operation of the button field, and multiplexing of a code is implemented. After the processing flow is dissociated from the button field, the processing flow can also be associated with other button fields, such that there is no need to write a code repeatedly. In some embodiments, other conditions may be added to the start conditions, such that other conditions also need to be satisfied before the processing flow is executed.

In some embodiments of the present disclosure, a field is associated with a first setting interface configured to set a field, and a processing flow is associated with a second setting interface configured to set a processing flow. Generating a target button field in a cell of a target table of a first online document includes: setting, in the first setting interface associated with the target button field, the target execution operation executed in response to determining that the target trigger condition of the target button is satisfied; and setting, in the second setting interface associated with the target processing flow, the target start condition of the target processing flow and the target operation content executed in response to determining that the target start condition is satisfied.

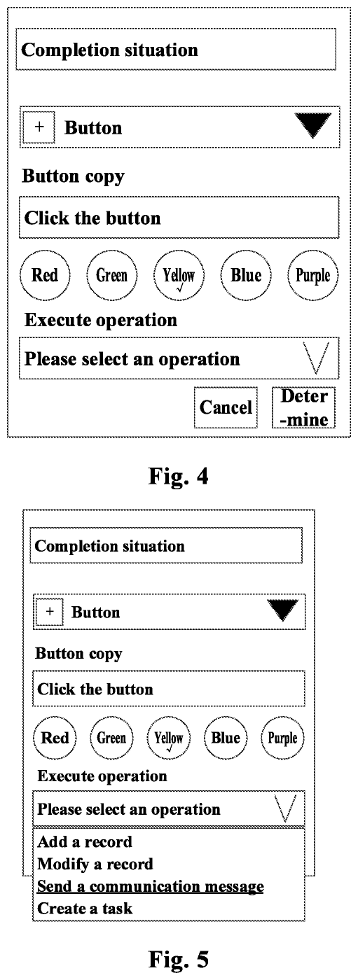

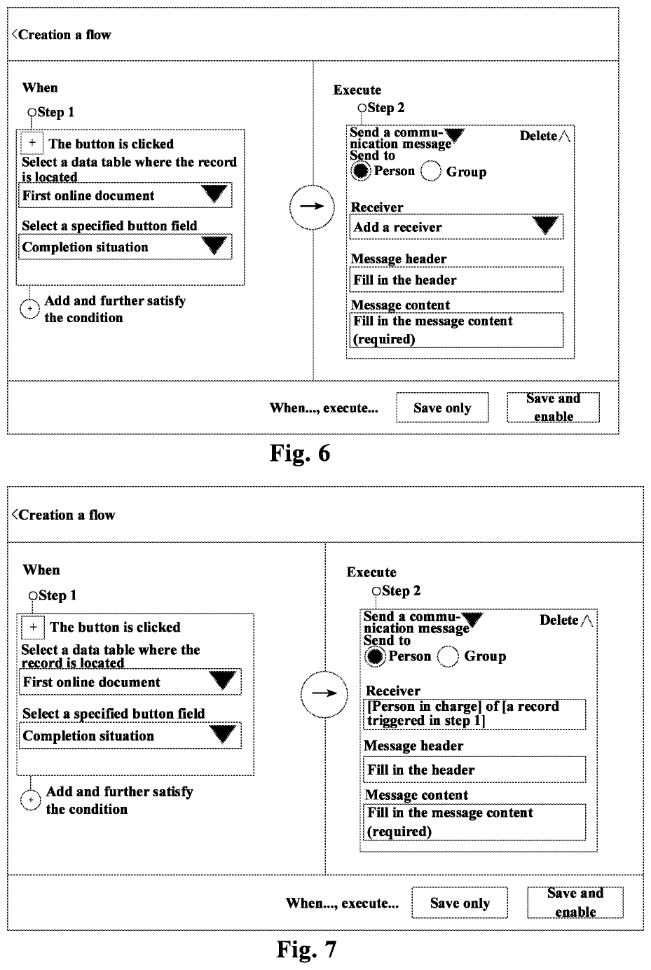

In some embodiments, the first setting interface may be a button field configuration interface, and the second setting interface may be a processing flow configuration interface. A button field is set when created, and a processing flow associated with the button field is designed. As shown in FIG. 4, a first setting interface is schematically displayed. In the first setting interface, a title (a column where the title is located) to which the target button field belongs may be displayed. “Completion situation” in FIG. 4 indicates that the target button field is a cell below the column of “Completion situation” in FIG. 3. The button as the field type may be displayed, and text displayed on the button may be displayed, that is, a button copy “Click the button” may be displayed on the button with text or emoji. The copy may be modified. For example, the button copy is modified to “Click to complete” in FIG. 3. A display color of the button may be further set in the first setting interface, and yellow is selected in FIG. 4. The execution operation may be selected in the first setting interface, as shown in FIG. 5. After an execution operation selection control is triggered, optional execution operations may be displayed. For example, sending a communication message may be selected as the target execution operation. As shown in FIG. 6, a second setting interface is displayed. A control (a check box below “When the following situation occurs” on a left side in FIG. 6) configured to set a start condition is displayed in the second setting interface. The target start condition may include “Click the button” by default. A control (a check box below “Execute the following operation” on a right side in FIG. 6) configured to set a start target operation content is displayed. The processing flow is set through the second setting interface without mixing with the first setting interface, so as to further achieve decoupling.

In some embodiments of the present disclosure, the second setting interface associated with the target processing flow is automatically jumped to after the target execution operation is selected in the first setting interface associated with the target button field.

In some embodiments, as shown in FIG. 5, assuming that “Send a communication message” is selected as the target execution operation, the second setting interface shown in FIG. 6 is automatically jumped to, so as to set a specific content of the communication message to be sent, such as to whom the communication message is sent, a title, a message content, etc. The content of the target operation content may use a reference value, and points to an object satisfying a certain condition by means of the reference value without writing a specific content, for example, a record, a cell in the record, a person executing an operation, an execution date, etc. may be referenced. That is to say, the specific content of the target operation content may be partially or completely referred to by a reference value without specifying who is involved. For example, as shown in FIG. 7, “person in charge of a record triggered in the first step” is written in the column of Receiver. In this way, the receiver is non-fixed. In a case that the “Click to complete” button in FIG. 2 is triggered, the person in charge is determined according to a record (row data) where the button is located, and then the record is sent to the corresponding person in charge, such that the target operation content is dynamically changed, further improving scalability and reusability.

In some embodiments of the present disclosure, the second setting interface associated with the target processing flow is automatically jumped to, a blank target button field is automatically generated in the target table. In some embodiments, after the second setting interface is automatically jumped to, it indicates that the target execution operation is selected. Therefore, for the target button field, the configuration is completed, such that the target button field can be generated. However, the target button field is not associated with the target processing flow at this time, and thus the target button field is blank. The blank target button field may have an empty target button, and the target button executes no processing flow after being triggered.

In some embodiments of the present disclosure, in a case that the target start condition and the target operation content are set and enabled in the second setting interface associated with the target processing flow, description information of the target processing flow is displayed in the first setting interface associated with the target button field, and otherwise, the description information is not displayed.

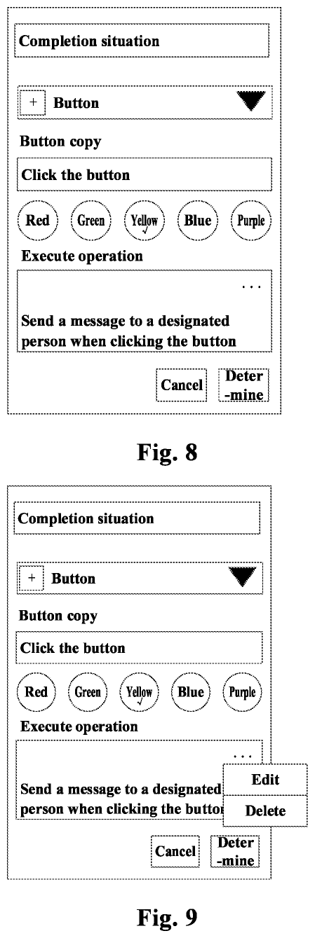

In some embodiments, after the setting is completed in the second setting interface associated with the target processing flow, saved and enabled, the description information of the target processing flow is displayed in the first setting interface associated with the target button field. The description information may include symbols and text. For example, in FIG. 8, “Send a message to a designated person when clicking the button” is displayed in a box of “Execute the operation”. In a case that the target processing flow has a plurality of executed operations, description of all or one operation may be displayed. For example, in a case that there is more than one operation, “When {the button is clicked}, execute {N} operations of {operation name}” is displayed. In a case that no target processing flow is “Saved and enabled” in the second setting interface, no description information is displayed.

In some embodiments of the present disclosure, the first setting interface associated with the target button field has a first control associated with the description information, and the first control is configured to, after being triggered, open the second setting interface associated with the target processing flow. In some embodiments, the first setting interface associated with the target button field has a second control associated with the description information, and the second control, after being triggered, deletes the target processing flow and the description information.

In some embodiments, as shown in FIG. 9, “. . . ” displayed on a right side of a box under the execution operation is clicked for more options to display an edit control and a delete control. “Edit” (the first control) is clicked to enter the second setting interface. “Delete” (the second control) is clicked to directly delete the target processing flow, and restore the description information to an initial state.

In some embodiments of the present disclosure, in a case that the target execution operation of the target button field, the target start condition and the target operation content are set and enabled, the target button field is generated, and the target button is in an available state. At this time, the target button may be triggered by clicking, etc., and the target processing flow may be executed.

In some embodiments of the present disclosure, in a case that the target execution operation of the target button field is set and enabled, but the target start condition and the target operation content are not set or not enabled after being set, the target button field is generated, and the target button is in an unavailable state. At this time, the target processing flow does not exist or is not enabled. Although the target button field is successfully created, the target button in the target button field is disabled and cannot be triggered by clicking.

In some embodiments of the present disclosure, the target start condition of the target processing flow includes a start event, an association table and an association field in the association table; and at least one of the following is satisfied: a start event of the target start condition is the target trigger condition by default, the association table of the target start condition is a currently present target table by default, the association field of the target start condition is a currently present target button field by default, the start event is alterable, the association table is alterable, and the association field is alterable.

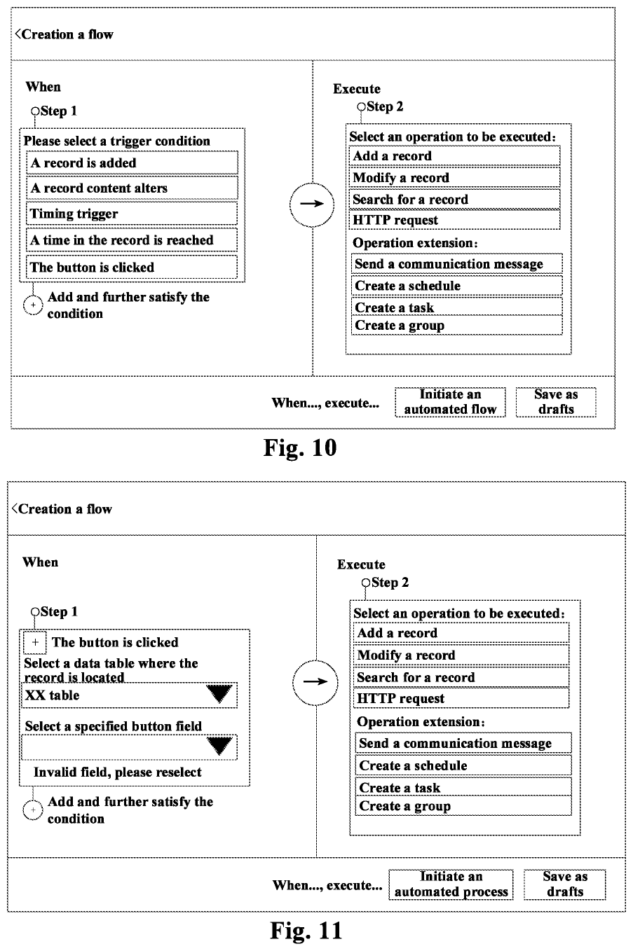

In some embodiments, the second setting interface associated with the target processing flow as shown in FIG. 7 may be entered through the first control (Edit) as shown in FIG. 9. A set control of the target start condition is displayed on a left side. It can be seen that the start event is the same as the target trigger condition “Click the button” by default, and a control of setting an association table and a control of setting an association field are displayed. A position of the clicked button is indicated through the association table and the association field. The association table is a target table where a currently selected button field is located by default. In the embodiment, the first online document may be a table document, such that the association table in FIG. 7 is the first online document, and the field is a currently located target button field (completion situation) by default. The start event, the association table, and the association field may be alterable. As shown in FIG. 10, the trigger condition may be switched to another condition such as a record is added and a record content alters.

In some embodiments of the present disclosure, the first online document has a third control, where the third control is configured to, after being triggered, enter a second setting interface for setting a processing flow, and the second setting interface is configured to set a processing flow. In a case that the start condition selected in the second setting interface includes a trigger button, and a selected table in the start condition has no button field, first prompt information is displayed, and/or a currently set processing flow is savable but not enabled.

In some embodiments, as shown in FIG. 3, a “flow” box displayed in an upper right corner of FIG. 3 may be a third control. The second setting interface is entered by clicking, etc. At this time, the second setting interface is configured to generate and set a new processing flow. As shown in FIG. 11, the second setting interface at this time is schematically displayed. In a case that a start condition selected includes triggering a button (“The button is clicked” in FIG. 11), a data table (table) where the button is located and a button field where the button is located need to be selected. At this time, in a case that the selected table has no button field, or the selected field is not a button field, the first prompt information “Invalid field, please reselect” is displayed as shown in FIG. 11. The first prompt information may also include changing a color of a selection box of a table or field, for example, changing to red, so as to prompt that the selected table or button is invalid. The newly generated processing flow may be saved, but cannot be enabled because the start condition is unsatisfied.

In some embodiments, one target button is associated with only one processing flow in an available state. In some embodiments, the button and the processing flow are in a one-to-one correspondence relation. The button field where the button is located is associated with the processing flow, that is, the button is associated with the processing flow. The button field where the button is located is disassociated from the processing flow, that is, the button is disassociated from the processing flow. In some embodiments, in a case that one target button is associated with at least two processing flows, the target button is unavailable. For example, button A is associated with processing flow 1, a user adds processing flow 2 and selects a button field where button A is located as a designated field of a start condition, then button A is unavailable, and button A may be grayed.

In some embodiments, description information of the target processing flow in a first setting interface associated with the target button field is synchronously updated after information of the target processing flow associated with the target button field is updated.

In some embodiments of the present disclosure, the method further includes: execute, in a case that an association relation between the target button field and the target processing flow is dissolved, at least one of the following: retaining the target button field, retaining the target processing flow, clearing description information of the target processing flow in a first setting interface associated with the target button field, and generating, after the target button field is associated with another processing flow, description information of the other processing flow in the first setting interface associated with the target button field.

In some embodiments, after the button field is disassociated from the processing flow, the original button field and the processing flow still exist, but the description information in the “Execute the operation” in the first setting interface of the original button field is cleared, and is restored to an initial state. In a case that the original processing flow is associated with another button field, the description information in the “Execute the operation” in the first setting interface of the other button field is updated synchronously.

In some embodiments of the present disclosure, in a case that the second setting interface associated with the target processing flow is entered by triggering the first control, that an association between the target start condition of the target processing flow and the target button field is dissolved in the second setting interface associated with the target processing flow, and that the target start condition is associated with another button field, the description information of the target processing flow in the first setting interface associated with the target button field is cleared, and the description information of the target processing flow is generated in a first setting interface associated with the another button field.

For example, in a case that the second setting interface of the processing flow associated with button A is entered by means of the first control of button A, and the designated field of the start condition is modified to another button B, the description information in the “Execute the operation” in the first setting interface associated with the button A is cleared, and is restored to the initial state, and the description information in the “Execute the operation” in the first setting interface associated with button B is updated synchronously.

In some embodiments of the present disclosure, in a case that the second setting interface associated with the target processing flow is entered by triggering the first control, and the target trigger condition is not included in the target start condition of the target processing flow set in the second setting interface associated with the target processing flow, the description information of the target processing flow in the first setting interface associated with the target button field is cleared.

For example, in a case that the second setting interface of the processing flow associated with button A is entered by means of the first control of button A, and the start event in the start condition is modified to another category such as “A new record is added”, the description information of “Execute the operation” in the first setting interface associated with button A is cleared, and is restored to the initial state.

In some embodiments of the present disclosure, in a case that the target processing flow is deleted, the target button field is retained, and description information of the target processing flow in the first setting interface associated with the target button field is cleared. In some embodiments of the present disclosure, in a case that the target button field is deleted, second prompt information is displayed in the second setting interface associated with the target processing flow, where the second prompt information is configured to report an error.

In some embodiments, the target processing flow may be deleted by means of a second button, and may also be deleted in a flow list interface. In a case that the target processing flow is deleted, the target button field is not deleted. Since the target processing flow is deleted, the corresponding description information is cleared and is restored to the initial state. In some embodiments, the target button field may be deleted in the first online document by triggering a delete control or the like. When the target button field is deleted, the association field in the second setting interface associated with the target processing flow does not exist, such that the second prompt information may be displayed in the second setting interface associated with the target processing flow, so as to report an error, and prompt that the target button field does not exist.

In some embodiments of the present disclosure, in response to determining that a target permission function is not enabled in the first online document, a user having first permission or second permission is capable of setting the execution operation of the button field. In some embodiments, in response to determining that the target permission function is enabled in the first online document, a user having the first permission but no second permission is incapable of setting the execution operation of the button field. In some embodiments, in response to determining that the target permission function is enabled in the first online document, a user having the first permission but no second permission is capable of generating an empty button unassociated with the execution operation. In some embodiments, in response to determining that the target permission function is enabled in the first online document, and a control identifier of a user having the first permission but no second permission hovers over a control configured to set the execution operation, third prompt information is displayed, where the third prompt information is configured to provide a prompt of a reason why the execution operation is incapable of being set.

In some embodiments, the second permission is higher than the first permission. The second permission may be administrable permission, the first permission may be editable permission, and the target permission function may be an advanced permission function. In the case that the target permission function is not enabled, the button field may be set with the first permission or the second permission. When the target permission function is enabled, for a user having the first permission (editable permission) but no second permission (administrable permission) on the first online document, a setting function for “Execute the operation” in the button field is disabled, and the third prompt information, such as prompting insufficient permission, may be displayed in the setting. The user may open the first setting interface of the existing button field, the setting function for “Execute the operation” is disabled, and clicking Save does not change the original setting for “Execute the operation”. The user may open an interface for creating a new button field. In a first setting interface of the newly created button field, a control for setting “Execute the operation” is disabled (automatic configuration cannot be performed). At this time, the newly created button field may be saved, and an empty button in a disabled state is generated in the newly created button field. The empty button is located in the button field and has no associated processing flow. When a mouse or other control identifiers hovers over the control for setting the execution operation, a prompt copy is displayed: the owner has enabled the target permission function, and the processing flow cannot be edited.

In some embodiments of the present disclosure, in response to determining that a target permission function is not enabled in the first online document, a user having first permission or second permission is capable of setting the start condition and the operation content of the processing flow. In some embodiments, in response to determining that the target permission function is enabled in the first online document, a user having the second permission is capable of setting the start condition and the operation content of the processing flow.

In some embodiments, when a target permission function is not enabled, a user having first permission or second permission is capable of setting the processing flow. After the target permission function is currently enabled, the processing flow may be set only with the second permission. Setting the processing flow by a user having the second permission is equivalent to allowing the user triggering the start condition to have the permission to execute the operation content. A process of indicating execution of the operation content may be executed by a robot account. Therefore, a user having the permission to trigger the start condition of the processing flow may trigger the execution of the operation content of the processing flow. In some embodiments, after the start condition is triggered, the robot account executes the operation content, such that the robot account needs to be added to the first online document in advance. Therefore, the user who sets the processing flow needs to have permission to add a collaborator to the first online document. In a case that the first online document restricts the permission of the collaborator added, the user who does not satisfy permission restriction of adding a collaborator cannot set the operation content of the processing flow. In some embodiments, as for a displayed target button, as long as it can be seen that the target button is in the available state and not hidden, the target button can be triggered to execute the target processing flow (the target processing flow may include reading and writing field data for which the user has no permission. When the target processing flow is set, the user setting the target processing flow has authorized the robot account to execute the operation).

In some embodiments, the present disclosure further provides an apparatus for processing information. The apparatus for processing information includes: a generation unit and a control unit.

The generation unit is configured to generate a target button field in a cell of a target table of a first online document in response to a first operation event, where a target button is displayed in the target button field, the target button field is a button field, a field type of the button field is button, the target button field has a target trigger condition, and the target button field is associated with a target processing flow.

The control unit is configured to execute the target processing flow in response to determining that the target trigger condition of the target button field is satisfied.

In some embodiments, a display style of the target button is relevant to at least one of an enabling state of the target button, an interaction situation between the target button and a control identifier, use permission of a current user for the target button, and an execution situation of the target processing flow; and/or, the enabling state of the target button is relevant to a presence state and/or a validity state of the target processing flow.

In some embodiments, the button field is associated with a trigger condition and an execution operation executed in response to determining that the trigger condition is satisfied; and a processing flow is associated with a start condition and an operation content executed in response to determining that the target start condition is satisfied.

A target start condition of the target processing flow includes the target button field in the target table and the target trigger condition, and a target operation content of the target processing flow is a specific operation content of a target execution operation associated with the target button field.

In some embodiments, a field is associated with a first setting interface configured to set a field, and a processing flow is associated with a second setting interface configured to set a processing flow.

Generating the target button field in the cell of the target table of the first online document includes: setting, in the first setting interface associated with the target button field, the target execution operation executed in response to determining that the target trigger condition of the target button is satisfied; and setting, in the second setting interface associated with the target processing flow, the target start condition of the target processing flow and the target operation content executed in response to determining that the target start condition is satisfied.

In some embodiments, the second setting interface associated with the target processing flow is automatically jumped to after the target execution operation is selected in the first setting interface associated with the target button field.

In some embodiments, a blank target button field is automatically generated in the target table after the second setting interface associated with the target processing flow is automatically jumped to.

In some embodiments, in a case that the target start condition and the target operation content are set and enabled in the second setting interface associated with the target processing flow, description information of the target processing flow is displayed in the first setting interface associated with the target button field, and otherwise, the description information is not displayed. In some embodiments, the first setting interface associated with the target button field has a

first control associated with the description information, and the first control is configured to, after being triggered, open the second setting interface associated with the target processing flow; and/or the first setting interface associated with the target button field has a second control associated with the description information, and the second control is configured to, after being triggered, delete the target processing flow and the description information.

In some embodiments, in a case that the target execution operation of the target button field, the target start condition and the target operation content are set and enabled, the target button field is generated, and the target button is in an available state.

In some embodiments, in a case that the target execution operation of the target button field is set and enabled, but the target start condition and the target operation content are not set or not enabled after being set, the target button field is generated, and the target button is in an unavailable state.

In some embodiments, the target start condition of the target processing flow includes a start event, an association table and an association field in the association table; and at least one of the following is satisfied: a start event of the target start condition is the target trigger condition by default, the association table of the target start condition is a currently present target table by default, the association field of the target start condition is a currently present target button field by default, the start event is alterable, the association table is alterable, and the association field is alterable.

In some embodiments, the first online document has a third control, where the third control is configured to, after being triggered, enter a second setting interface for setting a processing flow, and the second setting interface is configured to set a processing flow.

In some embodiments, in a case that the start condition selected in the second setting interface includes a trigger button, and a selected table in the start condition has no button field, first prompt information is displayed, and/or a currently set processing flow is savable but not enabled.

In some embodiments, one target button in an available state is associated with only one processing flow. In some embodiments, in a case that one target button is associated with at least two processing flows, the target button is unavailable. In some embodiments, description information of the target processing flow in a first setting interface associated with the target button field is synchronously updated after information of the target processing flow associated with the target button field is updated.

In some embodiments, the control unit is further configured to execute, in a case that an association relation between the target button field and the target processing flow is dissolved, at least one of the following: retaining the target button field, retaining the target processing flow, clearing description information of the target processing flow in a first setting interface associated with the target button field, and generating, after the target button field is associated with another processing flow, description information of the another processing flow in the first setting interface associated with the target button field.

In some embodiments, the control unit is further configured to clear, in a case that the second setting interface associated with the target processing flow is entered by triggering the first control, that an association between the target start condition of the target processing flow and the target button field is dissolved in the second setting interface associated with the target processing flow, and that the target start condition is associated with another button field, the description information of the target processing flow in the first setting interface associated with the target button field, and generate the description information of the target processing flow in a first setting interface associated with the another button field.

In some embodiments, the control unit is further configured to clear, in a case that the second setting interface associated with the target processing flow is entered by triggering the first control, and the target trigger condition is not included in the target start condition of the target processing flow set in the second setting interface associated with the target processing flow, the description information of the target processing flow in the first setting interface associated with the target button field.

In some embodiments, the control unit is further configured to retain, in a case that the target processing flow is deleted, the target button field, and clear description information of the target processing flow in the first setting interface associated with the target button field. In some embodiments, the control unit is further configured to display, in a case that the target

button field is deleted, second prompt information in the second setting interface associated with the target processing flow, where the second prompt information is configured to report an error.

In some embodiments, in response to determining that a target permission function is not enabled in the first online document, a user having first permission or second permission is capable of setting the execution operation of the button field.

In some embodiments, in response to determining that the target permission function is enabled in the first online document, a user having the first permission but no second permission is incapable of setting the execution operation of the button field.

In some embodiments, in response to determining that the target permission function is enabled in the first online document, a user having the first permission but no second permission is capable of generating an empty button unassociated with the execution operation.

In some embodiments, in response to determining that the target permission function is enabled in the first online document, and a control identifier of a user having the first permission but no second permission hovers over a control configured to set the execution operation, third prompt information is displayed, where the third prompt information is configured to provide a prompt of a reason why the execution operation is incapable of being set.

The second permission is higher than the first permission.

In some embodiments, in response to determining that a target permission function is not enabled in the first online document, a user having first permission or second permission is capable of setting the start condition and the operation content of the processing flow.

In some embodiments, in response to determining that the target permission function is enabled in the first online document, a user with the second permission is capable of setting the start condition and the operation content of the processing flow, where the second permission is higher than the first permission.

Since the embodiments of the apparatuses correspond to the method embodiments basically, reference can be made to the description of the method embodiments. The apparatus embodiments described above are merely schematic, the modules illustrated as separate modules may be separate or not. Some or all of the modules may be selected according to actual needs to achieve the purpose of the solutions of the embodiments. Those of ordinary skill in the art can understand and implement the present disclosure without making creative efforts.

The method and apparatus of the present disclosure have been described above based on embodiments and application instances. Moreover, the present disclosure further provides an electronic device and a computer-readable storage medium. The electronic device and the computer-readable storage medium are described below.

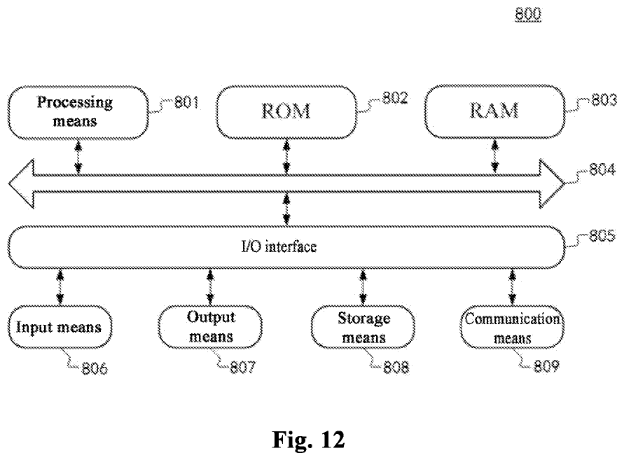

With reference to FIG. 12 below, a schematic structural diagram of an electronic device (for example, a terminal device or a server) 800 suitable for implementing an embodiment of the present disclosure is shown. The terminal device in the embodiment of the present disclosure may include, but is not limited to, mobile terminals such as mobile phones, notebook computers, digital broadcast receivers, personal digital assistants (PDA), tablet computers (PAD), portable multimedia players (PMP), in-vehicle terminals (for example, in-vehicle navigation terminals), etc., and fixed terminals such as digital televisions (TV), desktop computers, etc. The electronic device illustrated in the figure is merely an instance and should not impose any limitation on the functions and scope of use of the embodiments of the present disclosure.

The electronic device 800 may include a processing means (for example, a central processing unit, a graphics processing unit, etc.) 801 that may execute various appropriate actions and processes according to programs stored in a read-only memory (ROM) 802 or programs loaded from a storage means 808 into a random-access memory (RAM) 803. The RAM 803 also stores various programs and data needed for the operations of the electronic device 800. The processing means 801, the ROM 802, and the RAM 803 are connected to each other by means of a bus 804. An input/output (I/O) interface 805 is also connected to the bus 804.

Typically, the following means may be connected to the I/O interface 805: an input means 806 including, for example, a touch screen, a touch pad, a keyboard, a mouse, a camera, a microphone, an accelerometer, a gyroscope, etc .; an output means 807 including, for example, a liquid crystal display (LCD), a speaker, a vibrator, etc .; a storage means 808 including, for example, a magnetic tape, a hard disk, etc .; and a communication means 809. The communication means 809 may allow the electronic device 800 to be in wireless or wired communication with other devices to exchange data. While the figure illustrates an electronic device 800 having various means, it should be understood that not all of the illustrated apparatuses are required to be implemented or provided. More or fewer means may alternatively be implemented or provided.

In particular, according to embodiments of the present disclosure, a processes described above with reference to the flowcharts may be implemented as a computer software program. For example, embodiments of the present disclosure include a computer program product. The computer program product includes a computer program carried on a computer-readable medium, and the computer program includes a program code for executing the method illustrated in the flowchart. In such embodiments, the computer program may be downloaded and installed from a network by means of the communication means 809, or installed from the storage device 808, or installed from the ROM 802. When executed by the processing means 801, the computer program executes the above-described functions defined in the method of the embodiment of the present disclosure.

It should be noted that the computer-readable medium in the present disclosure may be a computer-readable signal medium or a computer-readable storage medium, or any combination of a computer-readable signal medium and a computer-readable storage medium. The computer-readable storage medium may include, but is not limited to, an electronic, magnetic, optical, electromagnetic, infrared, or semiconductor system, apparatus, or device, or any combination of the foregoing. More specific instance of the computer-readable storage medium may include, but is not limited to, an electrical connection based on one or more wires, a portable computer diskette, a hard disk, a random-access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination of the foregoing. In the present disclosure, the computer-readable storage medium may be any tangible medium that includes or stores a program for use by or in conjunction with an instruction execution system, apparatus, or device. In the present disclosure, the compute-readable signal medium may include a data signal propagating in a baseband or as part of a carry wave and carrying a computer-readable program code. Such a propagated data signal may have a variety of forms and may include, but is not limited to, an electromagnetic signal, an optical signal, or any suitable combination of the foregoing. The computer-readable signal medium may also be any computer-readable medium besides a computer-readable storage medium. The computer-readable signal medium can send, propagate, or transmit a program for use by or in conjunction with an instruction execution system, apparatus, or device. A program code included on a computer-readable medium may be transmitted by means of any suitable medium, including, but not limited to, wires, fiber optic cables, radio frequency (RF), etc., or any suitable combination of the foregoing.

In some embodiments, a client side and a server may communicate by using any currently known or future developed network protocol, such as a hypertext transfer protocol (HTTP), and may be interconnected with any form or medium of digital data communication (for example, a communication network). Instances of communication networks include a local area network (LAN), a wide area network (WAN), Internet work (for example, the Internet), and an end-to-end network (for example, an ad hoc end-to-end network), as well as any currently known or future developed network.

The computer-readable medium may be included in the above electronic device, and may also exist independently without being assembled into the electronic device.

The computer-readable medium carries one or more programs. When the one or more programs are executed by the electronic device, the electronic device executes the method according to the present disclosure.

A computer program code for performing operations of the present disclosure may be written in one or more programming languages, or combinations of the programming languages. The programming languages include object-oriented programming languages, such as Java, Smalltalk, and C++, and further include conventional procedural programming languages, such as the C programming language or similar programming languages. The program code may be executed entirely on a user computer, partly on a user computer, as a stand-alone software package, partly on a user computer and partly on a remote computer, or entirely on a remote computer or server. In the case involving a remote computer, the remote computer may be connected with a user computer through any kind of network, including a local area network (LAN) or a wide area network (WAN), or may be connected with an external computer (for example, connected through the Internet by using an Internet service provider).

The flowcharts and block diagrams in the accompanying drawings illustrate the architecture, functionality, and operations possibly implemented by the systems, methods, and computer program products according to various embodiments of the present disclosure. In this regard, each block in the flowcharts or block diagrams may represent a module, a program segment, or part of a code, and a module, a program segment, or part of a code includes one or more executable instructions for implementing a specified logical function. It should also be noted that in some alternative implementations, a function noted in a block may occur in a different order than an order noted in the figures. For example, two consecutive blocks may actually be executed substantially in parallel, or in a reverse order sometimes, depending on a function involved. It should also be noted that each block in the block diagrams and/or flowcharts, and combinations of blocks in the block diagrams and/or flowcharts, can be implemented by special purpose hardware-based systems that perform specified functions or operations, or can be implemented by combinations of special purpose hardware and computer instructions.

The units described in the embodiment of the present disclosure may be implemented in software or hardware. The name of a unit does not constitute a qualification of the unit itself under certain circumstances.

The functions described above herein may be executed at least partially by one or more hardware logic components. For example, without limitation, exemplary types of the hardware logic components that may be used include: a field programmable gate array (FPGA), an application specific integrated circuit (ASIC), an application specific standard product (ASSP), a system on chip (SOC), a complex programmable logic device (CPLD), etc.

In the context of the present disclosure, the machine-readable medium may be a tangible medium that may include or store a program for use by or in conjunction with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination of the foregoing. More specific instance of the machine-readable storage medium may include an electrical connection based on one or more wires, a portable computer diskette, a hard disk, a random-access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination of the foregoing.

According to one or more embodiments of the present disclosure, a method for processing information is provided. The method includes: generating a target button field in a cell of a target table of a first online document in response to a first operation event, where a target button is displayed in the target button field, the target button field is a button field, a field type of the button field is button, the target button field has a target trigger condition, and the target button field is associated with a target processing flow; and executing the target processing flow in response to determining that the target trigger condition of the target button field is satisfied.

According to one or more embodiments of the present disclosure, a method for processing information is provided. A display style of the target button is relevant to at least one of an enabling state of the target button, an interaction situation between the target button and a control identifier, use permission of a current user for the target button, and an execution situation of the target processing flow; and/or, the enabling state of the target button is relevant to a presence state and/or a validity state of the target processing flow.

According to one or more embodiments of the present disclosure, a method for processing information is provided. The button field is associated with a trigger condition and an execution operation executed in response to determining that the trigger condition is satisfied.

The processing flow is associated with a start condition and an operation content executed in response to determining that the target start condition is satisfied.

The target start condition of the target processing flow includes the target button field in the target table and the target trigger condition, and a target operation content of the target processing flow is a specific operation content of a target execution operation associated with the target button field.

According to one or more embodiments of the present disclosure, a method for processing information is provided. A field is associated with a first setting interface configured to set a field, and a processing flow is associated with a second setting interface configured to set a processing flow.

Generating the target button field in the cell of the target table of the first online document includes: setting, in the first setting interface associated with the target button field, the target execution operation executed in response to determining that the target trigger condition of the target button is satisfied; and setting, in the second setting interface associated with the target processing flow, the target start condition of the target processing flow and the target operation content executed in response to determining that the target start condition is satisfied.

According to one or more embodiments of the present disclosure, a method for processing information is provided. The second setting interface associated with the target processing flow is automatically jumped to after the target execution operation is selected in the first setting interface associated with the target button field.

According to one or more embodiments of the present disclosure, a method for processing information is provided. A blank target button field is automatically generated in the target table, after the second setting interface associated with the target processing flow is automatically jumped to.

According to one or more embodiments of the present disclosure, a method for processing information is provided. In a case that the target start condition and the target operation content are set and enabled in the second setting interface associated with the target processing flow, description information of the target processing flow is displayed in the first setting interface associated with the target button field, and otherwise, the description information is not displayed.

According to one or more embodiments of the present disclosure, a method for processing information is provided. The first setting interface associated with the target button field has a first control associated with the description information, and the first control is configured to, after being triggered, open the second setting interface associated with the target processing flow; and/or the first setting interface associated with the target button field has a second control associated with the description information, and the second control is configured to, after being triggered, delete the target processing flow and the description information.

According to one or more embodiments of the present disclosure, a method for processing information is provided. In a case that the target execution operation of the target button field, the target start condition and the target operation content are set and enabled, the target button field is generated, and the target button is in an available state; and in a case that the target execution operation of the target button field is set and enabled, but the target start condition and the target operation content are not set or not enabled after being set, the target button field is generated, and the target button is in an unavailable state.

According to one or more embodiments of the present disclosure, a method for processing information is provided. The target start condition of the target processing flow includes a start event, an association table and an association field in the association table; and at least one of the following is satisfied: a start event of the target start condition is the target trigger condition by default, the association table of the target start condition is a currently present target table by default, the association field of the target start condition is a currently present target button field by default, the start event is alterable, the association table is alterable, and the association field is alterable.

According to one or more embodiments of the present disclosure, a method for processing information is provided. The method satisfies at least one of the following: the first online document has a third control, where the third control is configured to, after being triggered, enter a second setting interface for setting a processing flow, and the second setting interface is configured to set a processing flow; and in a case that the start condition selected in the second setting interface includes a trigger button, and a selected table in the start condition has no button field, first prompt information is displayed, and/or a currently set processing flow is savable but enabled.

According to one or more embodiments of the present disclosure, a method for processing information is provided. The method satisfies at least one of the following: one target button in an available state is associated with only one processing flow; in a case that one target button is associated with at least two processing flows, the target button is unavailable; and description information of the target processing flow in a first setting interface associated with the target button field is synchronously updated after information of the target processing flow associated with the target button field is updated.

According to one or more embodiments of the present disclosure, a method for processing information is provided. The method further includes: executing, in a case that an association relation between the target button field and the target processing flow is dissolved, at least one of the following: retaining the target button field, retaining the target processing flow, clearing description information of the target processing flow in a first setting interface associated with the target button field, and generating, after the target button field is associated with another processing flow, description information of the another processing flow in the first setting interface associated with the target button field.

According to one or more embodiments of the present disclosure, a method for processing information is provided. At least one of the following is satisfied: in a case that the second setting interface associated with the target processing flow is entered by triggering the first control, that an association between the target start condition of the target processing flow and the target button field is dissolved in the second setting interface associated with the target processing flow, and that the target start condition is associated with another button field, the description information of the target processing flow in the first setting interface associated with the target button field is cleared, and the description information of the target processing flow is generated in a first setting interface associated with the another button field; and in a case that the second setting interface associated with the target processing flow is entered by triggering the first control, and the target trigger condition is not included in the target start condition of the target processing flow set in the second setting interface associated with the target processing flow, the description information of the target processing flow in the first setting interface associated with the target button field is cleared.

According to one or more embodiments of the present disclosure, a method for processing information is provided. At least one of the following is satisfied: in a case that the target processing flow is deleted, the target button field is retained, and description information of the target processing flow in the first setting interface associated with the target button field is cleared; and in a case that the target button field is deleted, second prompt information is displayed in the second setting interface associated with the target processing flow, where the second prompt information is configured to report an error.

According to one or more embodiments of the present disclosure, a method for processing information is provided. At least one of the following is satisfied: in response to determining that a target permission function is not enabled in the first online document, a user having first permission or second permission is capable of setting the execution operation of the button field; in response to determining that the target permission function is enabled in the first online document, a user having the first permission but no second permission is incapable of setting the execution operation of the button field; in response to determining that the target permission function is enabled in the first online document, a user having the first permission but no second permission is capable of generating an empty button unassociated with the execution operation; and in response to determining that the target permission function is enabled in the first online document, and a control identifier of a user having the first permission but no second permission hovers over a control configured to set the execution operation, third prompt information is displayed, where the third prompt information is configured to provide a prompt of a reason why the execution operation is incapable of being set; where the second permission is higher than the first permission.

According to one or more embodiments of the present disclosure, a method for processing information is provided. At least one of the following is satisfied: in response to determining that a target permission function is not enabled in the first online document, a user having first permission or second permission is capable of setting the start condition and the operation content of the processing flow; and in response to determining that the target permission function is enabled in the first online document, a user having the second permission is capable of setting the start condition and the operation content of the processing flow; where the second permission is higher than the first permission.

According to one or more embodiments of the present disclosure, an apparatus for processing information is provided. The apparatus includes a generation unit and a control unit.

The generation unit is configured to generate a target button field in a cell of a target table of a first online document in response to a first operation event, where a target button is displayed in the target button field, the target button field is a button field, a field type of the button field is button, the target button field has a target trigger condition, and the target button field is associated with a target processing flow.

The control unit is configured to execute the target processing flow in response to determining that the target trigger condition of the target button field is satisfied.

According to one or more embodiments of the present disclosure, an electronic device is provided. The electronic device includes at least one memory and at least one processor.

The at least one memory is configured to store a program code, and the at least one processor is configured to call the program code stored in the at least one memory, to execute the method according to any one of the above items.

According to one or more embodiments of the present disclosure, a computer-readable storage medium is provided. The computer-readable storage medium stores a program code. The program code causes, when executed by a processor, the processor to execute the above method.

The above description is merely illustrative of preferred embodiments of the present disclosure and principles of the technology employed. It should be understood by those skilled in the art that the disclosed scope involved in the present disclosure is not limited to the technical solutions in which the above-described technical features are specifically combined, but encompasses other technical solutions in which the above-described technical features or equivalent features thereof are arbitrarily combined without departing from the concept of the present disclosure, for example, technical solutions formed by interchanging the features described above with (non-limitative) technical features disclosed in the present disclosure that have similar functions.

Furthermore, although operations are depicted in a particular order, this should not be understood as requiring that such operations be performed in the particular order shown or in a sequential order. In certain circumstances, multitasking and parallel processing may be advantageous. Similarly, although several specific implementation details are included in the above discussion, these details should not be construed as limitations on the scope of the present disclosure. Some features that are described in the context of separate embodiments may also be implemented in combination in a single embodiment. Conversely, various features described in the context of a single embodiment can also be implemented in multiple embodiments separately or in any suitable sub-combination manner.

Although the subject matter has been described in language specific to structural features and/or methodological logical actions, it should be understood that the subject matter defined in the appended claims is not necessarily limited to the specific features or actions described above. On the contrary, the specific features and actions described above are merely instance forms of implementing the claims.

I/We claim:

1. A method for processing information, comprising:
generating a target button field in a cell of a target table of a first online document in response to a first operation event, wherein a target button is displayed in the target button field, the target button field is a button field, a field type of the button field is button, the target button field has a target trigger condition, and the target button field is associated with a target processing flow; and
executing the target processing flow in response to determining that the target trigger condition of the target button field is satisfied.

2. The method according to claim 1, wherein
a display style of the target button is relevant to at least one of an enabling state of the target button, an interaction situation between the target button and a control identifier, use permission of a current user for the target button, and an execution situation of the target processing flow; and/or
the enabling state of the target button is relevant to a presence state and/or a validity state of the target processing flow.

3. The method according to claim 1, wherein
the button field is associated with a trigger condition and an execution operation executed in response to determining that the trigger condition is satisfied;
a processing flow is associated with a start condition and an operation content executed in response to determining that the target start condition is satisfied; and
a target start condition of the target processing flow comprises the target button field in the target table and the target trigger condition, and a target operation content of the target processing flow is a specific operation content of a target execution operation associated with the target button field.

4. The method according to claim 3, wherein
a field is associated with a first setting interface configured to set a field, and a processing flow is associated with a second setting interface configured to set a processing flow; and
generating the target button field in the cell of the target table of the first online document comprises:
setting, in the first setting interface associated with the target button field, the target execution operation executed in response to determining that the target trigger condition of the target button is satisfied; and
setting, in the second setting interface associated with the target processing flow, the target start condition of the target processing flow and the target operation content executed in response to determining that the target start condition is satisfied.

5. The method according to claim 4, further comprising:
automatically jumping to the second setting interface associated with the target processing flow after the target execution operation is selected in the first setting interface associated with the target button field.

6. The method according to claim 5, further comprising:
automatically generating a blank target button field in the target table after the second setting interface associated with the target processing flow is automatically jumped to.

7. The method according to claim 4, further comprising:
in a case that the target start condition and the target operation content are set and enabled in the second setting interface associated with the target processing flow, displaying, in the first setting interface associated with the target button field, description information of the target processing flow, and otherwise, not displaying the description information.

8. The method according to claim 7, wherein
the first setting interface associated with the target button field has a first control associated with the description information, and the first control is configured to, after being triggered, open the second setting interface associated with the target processing flow; and/or
the first setting interface associated with the target button field has a second control associated with the description information, and the second control is configured to, after being triggered, delete the target processing flow and the description information.

9. The method according to claim 4, wherein
in a case that the target execution operation of the target button field, the target start condition and the target operation content are set and enabled, the target button field is generated, and the target button is in an available state; and
in a case that the target execution operation of the target button field is set and enabled, but the target start condition and the target operation content are not set or not enabled after being set, the target button field is generated, and the target button is in an unavailable state.

10. The method according to claim 3, wherein
the target start condition of the target processing flow comprises a start event, an association table and an association field in the association table; and
at least one of the following is satisfied: a start event of the target start condition is the target trigger condition by default, the association table of the target start condition is a currently present target table by default, the association field of the target start condition is a currently present target button field by default, the start event is alterable, the association table is alterable, and the association field is alterable.

11. The method according to claim 3, wherein at least one of the following is satisfied:
the first online document has a third control, wherein the third control is configured to, after being triggered, enter a second setting interface for setting a processing flow, and the second setting interface is configured to set a processing flow; and
in a case that the start condition selected in the second setting interface comprises a trigger button, and a selected table in the start condition has no button field, first prompt information is displayed, and/or a currently set processing flow is savable but not enabled.

12. The method according to claim 1, wherein at least one of the following is satisfied:
one target button in an available state is associated with only one processing flow;
in a case that one target button is associated with at least two processing flows, the target button is unavailable; and
description information of the target processing flow in a first setting interface associated with the target button field is synchronously updated after information of the target processing flow associated with the target button field is updated.

13. The method according to claim 1, further comprising: executing, in a case that an association relation between the target button field and the target processing flow is dissolved, at least one of the following:
retaining the target button field;
retaining the target processing flow;
clearing description information of the target processing flow in a first setting interface associated with the target button field; or
generating, after the target button field is associated with another processing flow, description information of the other processing flow in the first setting interface associated with the target button field.

14. The method according to claim 8, wherein at least one of the following is satisfied:
in a case that the second setting interface associated with the target processing flow is entered by triggering the first control, that an association between the target start condition of the target processing flow and the target button field is dissolved in the second setting interface associated with the target processing flow, and that the target start condition is associated with another button field, the description information of the target processing flow in the first setting interface associated with the target button field is cleared, and the description information of the target processing flow is generated in a first setting interface associated with the other button field; and
in a case that the second setting interface associated with the target processing flow is entered by triggering the first control, and the target trigger condition is not comprised in the target start condition of the target processing flow set in the second setting interface associated with the target processing flow, the description information of the target processing flow in the first setting interface associated with the target button field is cleared.

15. The method according to claim 4, wherein at least one of the following is satisfied:
in a case that the target processing flow is deleted, the target button field is retained, and description information of the target processing flow in the first setting interface associated with the target button field is cleared; and
in a case that the target button field is deleted, second prompt information is displayed in the second setting interface associated with the target processing flow, the second prompt information being configured to report an error.

16. The method according to claim 3, wherein at least one of the following is satisfied:
in response to determining that a target permission function is not enabled in the first online document, a user having first permission or second permission is capable of setting the execution operation of the button field;
in response to determining that the target permission function is enabled in the first online document, a user having the first permission but no second permission is incapable of setting the execution operation of the button field;
in response to determining that the target permission function is enabled in the first online document, a user having the first permission but no second permission is capable of generating an empty button unassociated with the execution operation; and
in response to determining that the target permission function is enabled in the first online document, and a control identifier of a user having the first permission but no second permission hovers over a control configured to set the execution operation, third prompt information is displayed, the third prompt information being configured to provide a prompt of a reason why the execution operation is incapable of being set;
wherein, the second permission is higher than the first permission.

17. The method according to claim 3, wherein at least one of the following is satisfied:
in response to determining that a target permission function is not enabled in the first online document, a user having first permission or second permission is capable of setting the start condition and the operation content of the processing flow; and
in response to determining that the target permission function is enabled in the first online document, a user having the second permission is capable of setting the start condition and the operation content of the processing flow;
wherein the second permission is higher than the first permission.

18. An electronic device, comprising:
at least one memory and at least one processor, wherein
the at least one memory is configured to store a program code, and the at least one processor is configured to call the program code stored in the at least one memory to:
generate a target button field in a cell of a target table of a first online document in response to a first operation event, wherein a target button is displayed in the target button field, the target button field is a button field, a field type of the button field is button, the target button field has a target trigger condition, and the target button field is associated with a target processing flow; and
execute the target processing flow in response to determining that the target trigger condition of the target button field is satisfied.

19. The electronic device according to claim 18, wherein
a display style of the target button is relevant to at least one of an enabling state of the target button, an interaction situation between the target button and a control identifier, use permission of a current user for the target button, and an execution situation of the target processing flow; and/or
the enabling state of the target button is relevant to a presence state and/or a validity state of the target processing flow.

20. A non-transitory computer-readable storage medium, storing a program code, wherein the program code causes, when executed by a processor, the processor to:
generate a target button field in a cell of a target table of a first online document in response to a first operation event, wherein a target button is displayed in the target button field, the target button field is a button field, a field type of the button field is button, the target button field has a target trigger condition, and the target button field is associated with a target processing flow; and
execute the target processing flow in response to determining that the target trigger condition of the target button field is satisfied.
